(19) United States
(12) Patent Application Publication
(10) Pub. No.: US 2013/0136969 A1
(43) Pub. Date: May 30, 2013

(54) BATTERY MODULE AND BATTERY ASSEMBLY USED IN BATTERY MODULE

(71) Applicants: Shunsuke Yasui, Osaka (JP); Masatoshi Nagayama, Osaka (JP); Takuya Nakashima, Osaka (JP)

(72) Inventors: Shunsuke Yasui, Osaka (JP); Masatoshi Nagayama, Osaka (JP); Takuya Nakashima, Osaka (JP)

(73) Assignee: PANASONIC CORPORATION, Osaka (JP)

(21) Appl. No.: 13/576,293

(22) PCT Filed: Dec. 27, 2011
(86) PCT No.: PCT/JP2011/007295

§ 371 Date: Jul. 31, 2012

(30) Foreign Application Priority Data
Jan. 25, 2011 (JP) 2011-012598

(51) Int. Cl. H01M 2/10

(52) U.S. Cl. CPC H01M 2/1016; H01M 2/1022; H01M 2/1077
USPC 429/99

(57) ABSTRACT

A battery module includes a plurality of battery assemblies stacked together. Each of the battery assemblies includes an insulating case which accommodates a plurality of cells. A first connection plate connects the same polarities of the cells, and a second connection plate connects polarities opposite the same polarities of the cells. The first connection plate includes a first connection terminal which protrudes in a direction opposite a direction toward the second connection plate. The second connection plate includes a second connection terminal which protrudes in a direction toward the first connection terminal. The first connection terminal protrudes outwardly of the case. The second connection terminal protrudes inwardly of the case. In the battery assemblies adjacent to each other in a stacking direction, the first connection terminal of one battery assembly and the second connection terminal of the other battery assembly are fitted to each other. The first connection terminal of one battery assembly protrudes inwardly of the case of the other battery assembly.

### TECHNICAL FIELD

The present disclosure relates to battery modules in which a plurality of battery assemblies each including a plurality of batteries are stacked, and the battery assemblies used in the battery modules.

### BACKGROUND ART

Battery packs including a plurality of batteries accommodated in a case, and capable of outputting a predetermined voltage and capacity are widely used as power sources of various devices, vehicles, etc. Specifically, a technique in which general-purpose batteries are connected together in parallel and/or in series to obtain modules of battery assemblies for outputting a predetermined voltage and capacity, and these battery modules are combined together to be applicable to various applications, is beginning to be used. This module forming technique can reduce the size and weight of the battery modules themselves by increasing the performance of the batteries accommodated in the battery modules. Thus, this module forming technique has various advantages, such as an increase in workability in assembling a battery pack, and improvement in flexibility in mounting the battery module in areas of limited space, such as a vehicle.

For example, battery modules using lithium ion secondary batteries have been developed as a power source for a vehicle. Here, it is necessary to form battery modules in which a plurality of battery assemblies are connected in series or connected in parallel to obtain high output and high capacity properties optimal for not only the lithium ion secondary batteries, but also various types of batteries.

Patent Document 1 discloses a method for forming a battery module in which battery assemblies each including a plurality of batteries accommodated in a case are assembled into a battery module by fastening a case to another with a bolt inserted in through holes formed at a peripheral portion of each of the cases.

### CITATION LIST

### Patent Document

Patent Document 1: Japanese Patent Publication No. 2006-147531

### SUMMARY OF THE INVENTION

### Technical Problem

However, according to the technique disclosed in Patent Document 1, the battery module is formed by fastening the battery assemblies to each other, and therefore, the positioning of the battery assemblies is difficult, and the assembly and disassembly of the battery module become complicated. Further, since the battery assemblies are fastened together with a bolt, a conductive part (an electrode terminal) is located outside the battery assembly. Thus, the battery module needs to be assembled with care to avoid an electric shock due to contact.

An objective of the present disclosure is to provide a battery module in which battery assemblies are easily assembled and disassembled, and in which it is possible to avoid an electric shock due to contact with a conductive part.

### Solution to the Problem

A battery module of the present disclosure includes a plurality of battery assemblies stacked together wherein each of the battery assemblies includes: an insulating case which accommodates a plurality of cells and in which same polarities of the plurality of cells are aligned; a first connection plate which connects the same polarities of the plurality of cells in parallel; and a second connection plate which connects polarities opposite the same polarities of the plurality of cells in parallel, the first connection plate and the second connection plate are located opposite each other with respect to the cells, the first connection plate includes a first connection terminal which protrudes in a direction opposite a direction toward the second connection plate, the second connection plate includes a second connection terminal which protrudes in a direction toward the first connection terminal, the first connection terminal protrudes outwardly of the case, the second connection terminal protrudes inwardly of the case, in the battery assemblies adjacent to each other in a stacking direction, the first connection terminal of one of the adjacent battery assemblies and the second connection terminal of the other battery assembly are fitted to each other and connected together in series, and the first connection terminal of the one of the adjacent battery assemblies protrudes inwardly of the case of the other battery assembly.

In this configuration, the first connection terminal of one battery assembly and the second connection terminal of the other battery assembly can be connected in series in the case. Thus, the battery assemblies can be easily assembled together, and it is possible to avoid an electric shock due to contact with a conductive part.

### Advantages of the Invention

According to the present disclosure, it is possible to provide a battery module in which battery assemblies are easily assembled and disassembled, and in which it is possible to avoid an electric shock due to contact with a conductive part.

### BRIEF DESCRIPTION OF THE DRAWINGS

FIG. 1 is a cross section illustrating a configuration of a cell used in a battery assembly according to an embodiment of the present disclosure.

FIG. 2(a) is a top view of a battery assembly according to an embodiment of the present disclosure. FIG. 2(b) is a cross section taken along the line B-B of FIG. 2(a).

FIG. 3(a) is an oblique view from above the battery assembly. FIG. 3(b) is an oblique view from under the battery assembly.

FIG. 4 is a cross section illustrating a configuration of a battery module according to an embodiment of the present disclosure.

FIG. 5 is a cross section illustrating a configuration of a battery module according to another embodiment of the present disclosure.

FIG. 6 is a top view of a battery assembly according to another embodiment of the present disclosure.

### DESCRIPTION OF EMBODIMENT

An embodiment of the present disclosure will be described below in detail based on the drawings. The present disclosure is not limited to the embodiment described below. Further, the embodiment can be modified without deviating from the effective scope of the present disclosure, and can be combined with other embodiments.

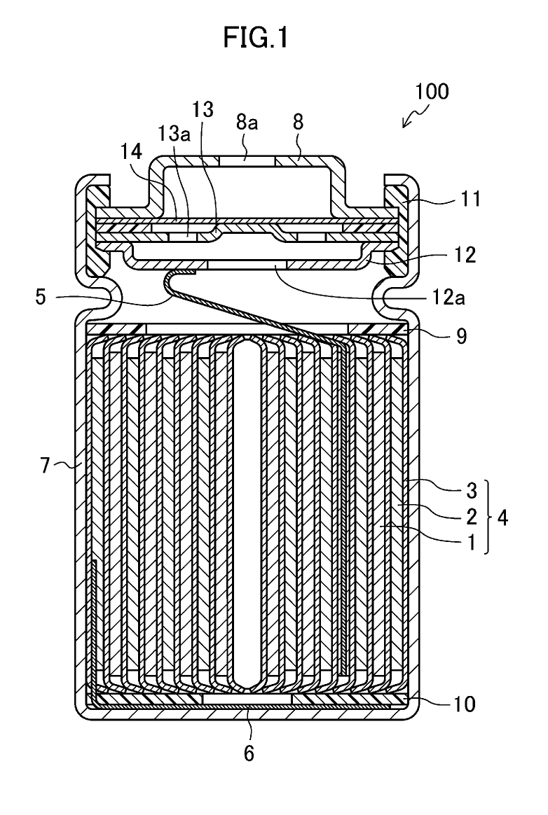

FIG. 1 is a cross section schematically illustrating a configuration of a battery (hereinafter referred to as a “cell”) 100 used in a battery assembly according to an embodiment of the present disclosure.

For example, a cylindrical lithium ion secondary battery as shown in FIG. 1 can be used as the cell 100 included in the battery assembly of the present disclosure.

The lithium ion secondary battery may be a general-purpose battery used as a power source of portable electronic devices, such as laptop computers. In this case, a high-performance general-purpose battery can be used as the cell in the battery module, and thus, performance enhancement and cost reduction of the battery module can be easily made. Further, the cell 100 includes a safety mechanism which releases a gas to the outside when the pressure in the battery increases due to an internal short circuit, etc. A concrete configuration of the cell 100 will be described below with reference to FIG. 1.

As shown in FIG. 1, an electrode group 4 formed by winding a positive electrode 1 and a negative electrode 2 with a separator 3 interposed between the positive electrode 1 and the negative electrode 2 is accommodated in a battery case 7 with a nonaqueous electrolyte. Insulating plates 9, 10 are disposed above and under the electrode group 4. The positive electrode 1 is joined to a filter 12 via a positive electrode lead 5. The negative electrode 2 is joined to a bottom of the battery case 7, which also serves as a negative electrode terminal, via a negative electrode lead 6.

The filter 12 is connected to an inner cap 13, and a raised portion of the inner cap 13 is joined to a metal valve 14. Moreover, the valve 14 is connected to a terminal plate 8 which also serves as a positive electrode terminal. The terminal plate 8, the valve 14, the inner cap 13, and the filter 12 together seal an opening of the battery case 7 via a gasket 11.

When the pressure in the cell 100 is increased due to an internal short circuit, etc., the valve 14 expands toward the terminal plate 8, and if the joint between the inner cap 13 and the valve 14 is released, a current path is interrupted. When the pressure in the cell 100 further increases, the valve 14 ruptures. Thus, the gas generated in the cell 100 is released outside via a through hole 12a of the filter 12, a through hole 13a of the inner cap 13, the ruptured portion of the valve 14, and a release portion 8a of the terminal plate 8.

The safety mechanism for releasing the gas generated in the cell 100 to the outside is not limited to the structure shown in FIG. 1, and may have other structures.

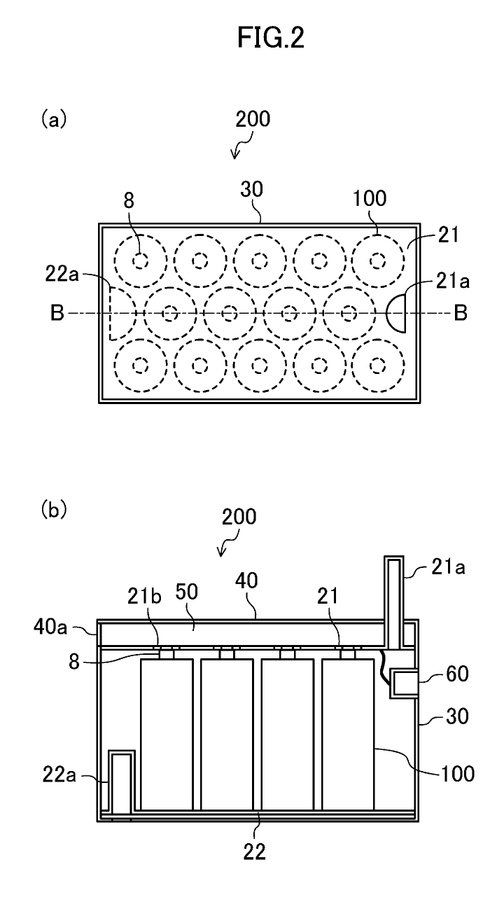

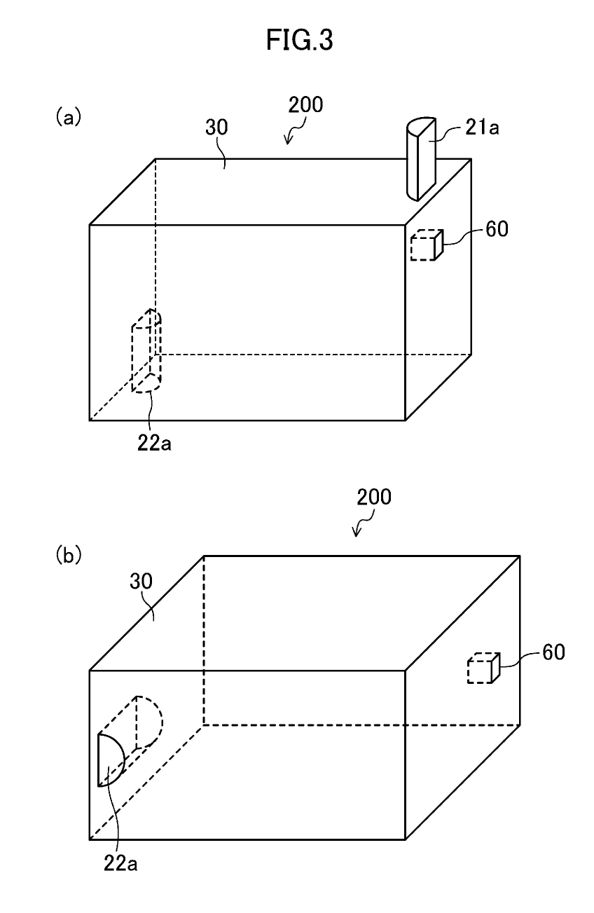

Next, a configuration of a battery assembly 200 according to an embodiment of the present disclosure will be described with reference to FIGS. 2(a) and 2(b) and FIGS. 3(a) and 3(b). FIG. 2(a) is a top view of the battery assembly 200. FIG. 2(b) is a cross section taken along the line B-B of FIG. 2(a). FIG. 3(a) is an oblique view from above the battery assembly 200. FIG. 3(b) is an oblique view from under the battery assembly 200.

As shown in FIGS. 2(a) and 2(b), the battery assembly 200 includes a plurality of cells 100 accommodated in an insulating case 30 in which the same polarities of the cells 100 are aligned. Positive electrode terminals 8 of the plurality of cells 100 are connected together in parallel via a positive electrode connection plate (a first connection plate) 21. Negative electrode terminals (i.e., the bottom of the battery case 7) of the plurality of cells 100 are connected together in parallel via a negative electrode connection plate (i.e., a second connection plate) 22. The positive electrode connection plate 21 and the negative electrode connection plate 22 are located opposite each other with respect to the cells 100.

The positive electrode connection plate 21 includes a positive electrode connection terminal (a first connection terminal) 21a which protrudes in a direction opposite a direction toward the negative electrode connection plate 22 (in a direction from the negative electrode terminal side to the positive electrode terminal side of the cell 100). The negative electrode connection plate 22 includes a negative electrode connection terminal (a second connection terminal) 22a which protrudes in a direction toward the positive electrode connection terminal 21a. As shown in FIGS. 3(a) and 3(b), the positive electrode connection terminal 21a protrudes outwardly of the case 30, whereas the negative electrode connection terminal 22a protrudes inwardly of the case 30.

A configuration of the battery assembly 200 according to the present embodiment will be described in more detail with reference to FIGS. 2(a) and 2(b) and FIGS. 3(a) and 3(b).

As shown in FIG. 2(a), the plurality of cells (i.e., cylindrical batteries) 100 are accommodated in the case 30 in a staggered manner (arranged in three rows of five, four, and five cells in FIG. 2(a)) and comprise the battery assembly 200. The positive electrode terminals 8 of the cells 100 are aligned in the same direction, and the plurality of cells 100 are electrically connected together in parallel. Thus, even if one of the cells 100 included in the battery assembly 200 is damaged, current supply in the battery module (as well as in the battery pack) is ensured in the battery module in which a plurality of battery assemblies 200 are assembled (as well as in the battery pack in which a plurality of battery modules are assembled).

Specifically, as shown in FIG. 2(b), the positive electrode connection plate 21 and the negative electrode connection plate 22 are provided such that the cells 100 are vertically sandwiched between the positive electrode connection plate 21 and the negative electrode connection plate 22 in the case 30. The positive electrode connection plate 21 is connected to the positive electrode terminal 8 of each the cells 100. The negative electrode connection plate 22 is connected to the negative electrode terminal of each of the cells 100 (i.e., the bottom of the battery case 7). Thus, the cells 100 are electrically connected together in parallel by the positive electrode connection plate 21 and the negative electrode connection plate 22.

The positive electrode connection plate 21 and the negative electrode connection plate 22 are made of electrically conductive metal, such as copper (Cu) and nickel (Ni). The positive electrode connection plate 21 includes the positive electrode connection terminal 21a in a projected shape (in a cylindrical shape) which protrudes outwardly of the case 30. The negative electrode connection plate 22 includes the negative electrode connection terminal 22a in a recessed shape (in a hollow cylindrical shape) which protrudes inwardly of the case 30.

The positive electrode connection plate 21 is provided to be in close contact with one end of each of the cells 100 (with the positive electrode terminal 8 in the present embodiment). An exhaust duct 50 is provided between the positive electrode connection plate 21 and a lid 40 of the case 30. The release portion 8a of the cell 100 communicates with the exhaust duct 50 through an opening 21b formed in the positive electrode connection plate 21. Accordingly, high temperature gas released from the release portion 8a of a cell 100 is released to the exhaust duct 50 through the opening 21b formed in the positive electrode connection plate 21. The exhaust duct 50 is hermetically sealed from the plurality of cells 100. Thus, the high temperature gas released to the exhaust duct 50 can be released to the outside of the battery assembly 200 through a release opening 40a formed in the lid 40, without exposing adjacent cells 100 to the high temperature gas.

As shown in FIGS. 3(a) and 3(b), the battery assembly 200 includes, in an upper portion of the case 30, the positive electrode connection terminal 21a in a projected shape (in a cylindrical shape), and in a lower portion of the case 30, the negative electrode connection terminal 22a in a recessed shape (in a hollow cylindrical shape). The external diameter of the positive electrode connection terminal 21a and the internal diameter of the negative electrode connection terminal 22a are generally the same so that a plurality of battery assemblies 200 can be stacked and electrically connected together.

The positive electrode connection terminal 21a and the negative electrode connection terminal 22a are positioned at opposite locations in a horizontal direction of the drawings. In this structure, the lengths of current paths of all the cells 100, from the positive electrode connection terminal 21a through the cell 100 to the negative electrode connection terminal 22a, are approximately the same. Thus, it is possible to make the degree of consumption of all the cells 100 uniform.

The case 30 is made of a thermally conductive resin. Thus, in the battery assembly 200, components other than the positive electrode connection terminal 21a and the negative electrode connection terminal 22a are electrically insulative, and thus, it is possible to avoid an electric shock due to contact.

A measurement terminal 60 may be embedded in a side surface of the case 30. The measurement terminal 60 is for measuring the temperature and the voltage of the battery assembly 200, and is connected to the positive electrode connection plate 21 or the negative electrode connection plate 22 of the battery assembly 200. The temperature and the voltage of the battery assembly 200 can be measured using a measurement device of which an external terminal is connected to the measurement terminal 60. In this structure, a conductive part of the measurement terminal 60 is also located in the case 30.

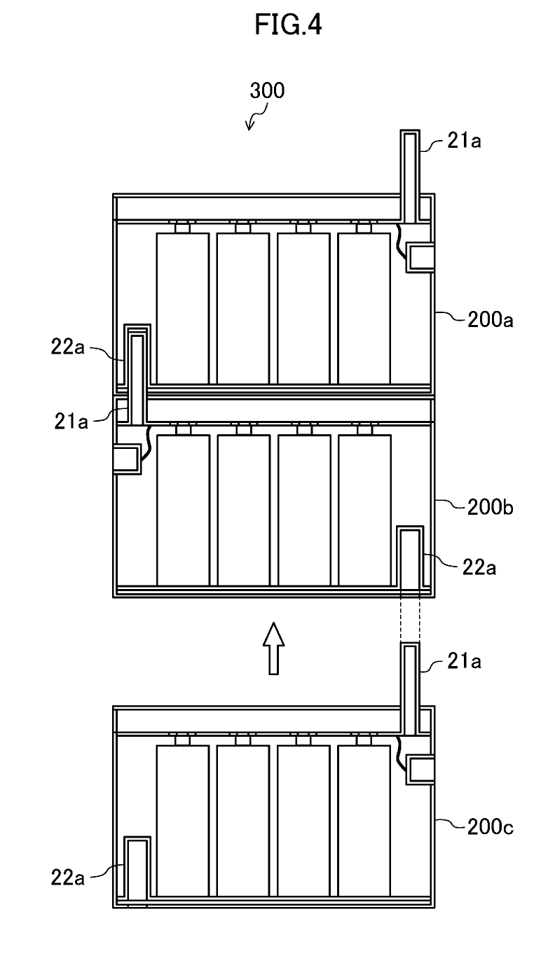

Next, a configuration of a battery module 300 according to the present embodiment will be described with reference to FIG. 4. FIG. 4 is a cross section illustrating a configuration of the battery module 300 according to the present embodiment. The battery assembly 200a and the battery assembly 200b show the state where the battery assemblies are already assembled. The battery assembly 200c corresponds to the state before assembly.

As shown in FIG. 4, the battery module 300 according to the present embodiment includes a plurality of battery assemblies 200a-200c stacked together. According to the present embodiment, in the battery assemblies adjacent to each other in a stacking direction, the positive electrode connection terminal (the first connection terminal) 21a of one of the adjacent battery assemblies (the battery assembly 200b) and the negative electrode connection terminal (the second connection terminal) 22a of the other battery assembly 200a are fitted to each other and connected together in series. That is, the positive electrode connection terminal 21a of the battery assembly 200b protrudes inwardly of the case 30 of the battery assembly 200a. The battery assembly 200b and the battery assembly 200c are stacked together in a similar manner.

In the above configuration, the positive electrode connection terminal 21a of the battery assembly 200a and the negative electrode connection terminal 22a of the battery assembly 200b can be connected together in series in the case 30. Thus, it is possible to easily assemble the battery assemblies, and possible to avoid an electric shock due to contact with the positive electrode connection terminal 21a (i.e., a conductive part) which protrudes outwardly of the case 30. Accordingly, it is possible to provide the battery module 300 in which the battery assemblies 200 can be easily assembled and disassembled, and in which it is possible to avoid an electric shock due to contact with a conductive part.

The shapes of the positive electrode connection terminal 21a and the negative electrode connection terminal 22a are not specifically limited. For example, in the case where the positive electrode connection terminal 21a has a cylindrical shape, and the negative electrode connection terminal 22a has a hollow cylindrical shape, the outer circumferential surface of the positive electrode connection terminal 21a is fitted to the inner circumferential surface of the negative electrode connection terminal 22a, thereby connecting the positive electrode connection terminal 21a and the negative electrode connection terminal 22a in series.

It is preferable that at least one of the positive electrode connection terminal 21a or the negative electrode connection terminal 22a is elastically deformed and fitted to the other connection terminal. In this structure, it is possible to increase the contact area between the positive electrode connection terminal 21a and the negative electrode connection terminal 22a, and reduce a contact resistance.

The positive electrode connection terminal 21a and the negative electrode connection terminal 22a may be integrally formed with the positive electrode connection plate 21 and the negative electrode connection plate 22, respectively. In this structure, the number of components can be reduced, thereby making it possible to reduce the assembly steps and assembly costs. The positive electrode connection terminal 21a (or the negative electrode connection terminal 22a) can be integrally formed with the positive electrode connection plate 21 (or the negative electrode connection plate 22) by, for example, deep drawing.

The arrangement of the plurality of cells 100 is not specifically limited, but it is preferable to alternately arrange a row of m cells and a row of m-1 cells in a staggered manner in the case 30 as shown in FIG. 2(a). In this case, the positive electrode connection terminal 21a and the negative electrode connection terminal 22a can be located at the opposite ends of the row of m-1 cells. Accordingly, it is possible to provide the positive electrode connection terminal 21a and the negative electrode connection terminal 22a without an increase in volume of the battery assembly 200.

The configuration of the battery module 300 according to the present embodiment will be described in more detail with reference to FIG. 4.

As shown in FIG. 4, the plurality of battery assemblies 200a-200c are arranged such that the positive electrodes or the negative electrodes of the cells in the respective battery assemblies face in the same direction (a vertical direction in the drawing), and that the positive electrode connection terminal 21a and the negative electrode connection terminal 22a are positioned opposite each other in the horizontal direction of the drawing in adjacent battery assemblies. In this structure, it is possible to combine the negative electrode connection terminal 22a of the battery assembly 200a and the positive electrode connection terminal 21a of the battery assembly 200b, and combine the negative electrode connection terminal 22a of the battery assembly 200b and the positive electrode connection terminal 21a of the battery assembly 200c. It is possible to easily assemble the battery assemblies 200 together by combining the positive electrode connection terminal 21a and the negative electrode connection terminal 22a as described above. Further, it is possible to easily disassemble the battery assemblies 200 by separating the positive electrode connection terminal 21a and the negative electrode connection terminal 22a from each other.

Further, the plurality of battery assemblies 200 can be connected in series by combining the positive electrode connection terminals 21a and the negative electrode connection terminals 22a of the plurality of battery assemblies 200. In the state where the plurality of battery assemblies 200 are assembled, the positive electrode connection terminals 21a and the negative electrode connection terminals 22a of the plurality of battery assemblies 200 are combined together in the case 30 made of an insulating material. This means that the conductive part of each of the battery assemblies 200 is accommodated in the battery case, and thus, it is possible to avoid an electric shock due to contact with the conductive part.

Since the measurement terminal 60 of the battery assembly 200 protrudes inwardly of the case 30, it is possible to avoid an electric shock due to contact of the measurement terminal 60 with a conductive part. Further, since the measurement terminal 60 is provided on a side surface of the battery module 300, an external terminal of a measurement device can be easily connected to the measurement terminal 60.

In the battery module 300 formed by assembling the plurality of battery assemblies 200, only the positive electrode connection terminal 21a of the battery assembly 200a and the negative electrode connection terminal 22a of the battery assembly 200c are exposed as conductive parts. The positive electrode connection terminal 21a of the battery assembly 200a and the negative electrode connection terminal 22a of the battery assembly 200c are respectively connected to a positive electrode and a negative electrode of a device to which the battery module 300 is connected, thereby making it possible to supply electric power to the device.

The positive electrode connection terminal 21a and the negative electrode connection terminal 22a are configured to have a function similar to a Faston terminal or a slot-in connector. Accordingly, the battery assemblies 200 can be electrically connected together, and can be assembled easily in terms of structure.

In the above configuration, the positive electrode connection terminal 21a of the positive electrode connection plate 21 and the negative electrode connection terminal 22a of the negative electrode connection plate 22 form a combination structure, and only the positive electrode connection terminal 21a and the negative electrode connection terminal 22a are exposed at the surface of the resin case 30. Thus, the battery assemblies 200 can be easily assembled, and moreover, it is possible to avoid an electric shock due to contact with a conductive part because the conductive part is not located outside the battery assembly 200.

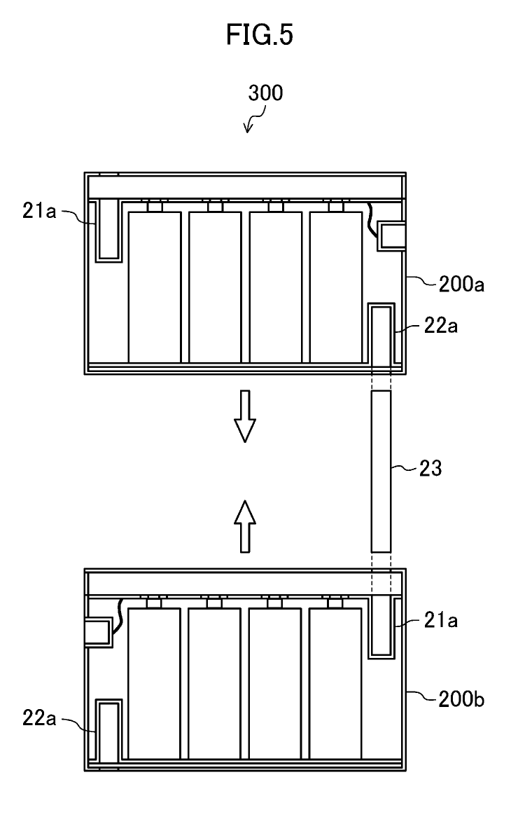

The present disclosure has been described by way of the preferred embodiment. However, the embodiment described above is not intended to limit the invention, and can be modified in various ways. For example, in the above embodiment, the positive electrode connection terminal (i.e., the first connection terminal) 21a protrudes outwardly of the case 30 as shown in FIG. 2(b), but the positive electrode connection terminal 21a may protrude inwardly of the case 30, similar to the negative electrode connection terminal (i.e., the second connection terminal) 22a. In this case, each of the positive electrode connection terminal 21a and the negative electrode connection terminal 22a of each of the battery assemblies 200a and 200b adjacent to each other in a stacking direction has a hollow cylindrical shape as shown in FIG. 5. A cylindrical connecting member 23 having an outer circumferential surface which comes in contact with the inner circumferential surfaces of the positive electrode connection terminal 21a and the negative electrode connection terminal 22a is fitted into the positive electrode connection terminal 21a and the negative electrode connection terminal 22a, thereby connecting the positive electrode connection terminal 21a and the negative electrode connection terminal 22a in series. The internal diameter of the positive electrode connection terminal 21a and the internal diameter of the negative electrode connection terminal 22a are generally the same.

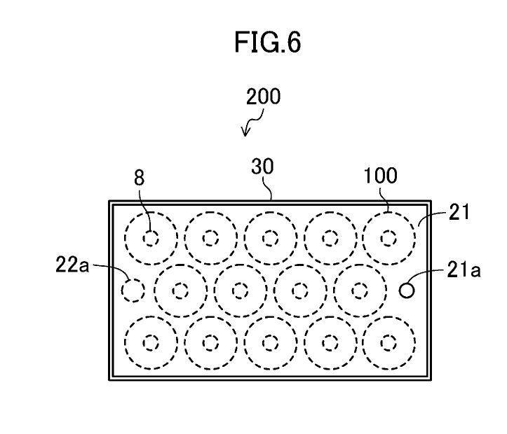

In the above embodiment, each of the positive electrode connection terminal 21a and the negative electrode connection terminal 22a has a half-cylindrical shape as shown in FIG. 2(a), but may have a cylindrical shape as shown in FIG. 6. Further, the positive electrode connection terminal 21a may be in a hollow cylindrical shape or may be in a solid cylindrical shape.

In the above embodiment, the case 30 is made of a thermally conductive resin, but may be made of a metal plate whose surface is covered with a resin layer. In this structure, it is possible to strengthen the case, and increase the thermal conductivity of the case.

In the above embodiment, as shown in FIG. 2(a), the positive electrode connection terminal 21a and the negative electrode connection terminal 22a are located at the opposite ends of the row in the middle (i.e., the row including four cells 100), but the cells 100 located in a center portion of the row in the middle may be removed and the positive electrode connection terminal 21a and the negative electrode connection terminal 22a may be placed in a center portion of the battery assembly 200. In this structure, it is possible to align the release opening 40a for releasing the exhaust gas from a cell 100 through the exhaust duct 50, the measurement terminal 60, etc., with each other. In this case, the length of current path from the positive electrode connection terminal 21a through the cell 100 to the negative electrode connection terminal 22a, slightly differs among the cells 100 in the center portion and the cells 100 in the peripheral portion, but the difference is equal to or shorter than half the length of the outer dimension of the battery assembly 200.

The positive electrode connection terminal 21a and the negative electrode connection terminal 22a are located at the opposite ends of the row of the cells 100 in the middle, but two positive electrode connection terminals 21a may be located at one end of the row of the cells 100 in the middle, and two negative electrode connection terminals 22a may be located at the other end of the same row. In this structure, the strength of the assembly of the battery assemblies 200 is increased, and the length of the current path can be doubled. As a result, it is possible to avoid heat generation in the positive electrode connection plate 21 and the negative electrode connection plate 22.

### INDUSTRIAL APPLICABILITY

A battery module of present disclosure is useful as a power source for driving vehicles, electric motorcycles, electric play equipment, etc.

### DESCRIPTION OF REFERENCE CHARACTERS

1 positive electrode

2 negative electrode

3 separator

4 electrode group

5 positive electrode lead

6 negative electrode lead

7 battery case

8 positive electrode terminal (terminal plate)

8a release portion

9, 10 insulating plate

11 gasket

12 filter

12a, 13a through hole

13 inner cap

14 valve

21 positive electrode connection plate (first connection plate)

21a positive electrode connection terminal (first connection terminal)

21b opening

22 negative electrode connection plate (second connection plate)

22a negative electrode connection terminal (second connection terminal)

23 connecting member

30 case

40 lid

40a release opening

50 exhaust duct

60 measurement terminal

100 cell

200 battery assembly

300 battery module

1. A battery module, comprising:
a plurality of battery assemblies stacked together, wherein
each of the battery assemblies includes
an insulating case which accommodates a plurality of cells and in which same polarities of the plurality of cells are aligned,
a first connection plate which connects the same polarities of the plurality of cells in parallel, and
a second connection plate which connects polarities opposite the same polarities of the plurality of cells in parallel,
the first connection plate and the second connection plate are located opposite each other with respect to the cells,
the first connection plate includes a first connection terminal which protrudes in a direction opposite a direction toward the second connection plate,
the second connection plate includes a second connection terminal which protrudes in a direction toward the first connection terminal,
the first connection terminal protrudes outwardly of the case,
the second connection terminal protrudes inwardly of the case,
in the battery assemblies adjacent to each other in a stacking direction, the first connection terminal of one of the adjacent battery assemblies and the second connection terminal of the other battery assembly are fitted to each other and connected together in series, and
the first connection terminal of the one of the adjacent battery assemblies protrudes inwardly of the case of the other battery assembly.

2. The battery module of claim 1, wherein
the first connection terminal has a cylindrical shape,
the second connection terminal has a hollow cylindrical shape, and
an outer circumferential surface of the first connection terminal is fitted to an inner circumferential surface of the second connection terminal.

3. The battery module of claim 1, wherein
at least one of the first connection terminal or the second connection terminal is elastically deformed and fitted to the other connection terminal.

4. The battery module of claim 1, wherein
the first connection terminal is integrally formed with the first connection plate, and
the second connection terminal is integrally formed with the second connection plate.

5. The battery module of claim 1, wherein
the plurality of cells are accommodated in the case such that a row of m cells and a row of m-1 cells are alternately arranged in a staggered manner, and
the first connection terminal and the second connection terminal are located at opposite ends of the row of m-1 cells.

6. The battery module of claim 1, wherein
the first connection terminal protrudes inwardly of the case, instead of protruding outwardly of the case,
the first connection terminal has a hollow cylindrical shape,
the second connection terminal has a hollow cylindrical shape, and
a cylindrical connecting member having an outer circumferential surface which comes in contact with an inner circumferential surface of the first connection terminal and an inner circumferential surface of the second connection terminal is fitted into the first connection terminal and the second connection terminal, thereby connecting the first connection terminal and the second connection terminal in series.

7. A battery assembly used in the battery module of claim 1, wherein
the battery assembly includes
an insulating case which accommodates a plurality of cells and in which same polarities of the plurality of cells are aligned,
a first connection plate which connects the same polarities of the plurality of cells in parallel, and
a second connection plate which connects polarities opposite the same polarities of the plurality of cells in parallel,
the first connection plate and the second connection plate are located opposite each other with respect to the cells,
the first connection plate includes a first connection terminal which protrudes in a direction opposite a direction toward the second connection plate,
the second connection plate includes a second connection terminal which protrudes in a direction toward the first connection terminal,
the first connection terminal protrudes outwardly of the case, and
the second connection terminal protrudes inwardly of the case.

8. The battery assembly of claim 7, wherein
the first connection terminal has a cylindrical shape,
the second connection terminal has a hollow cylindrical shape, and
an external diameter of the first connection terminal is approximately the same as an internal diameter of the second connection terminal.

9. The battery assembly of claim 7, wherein
the first connection terminal is integrally formed with the first connection plate, and
the second connection terminal is integrally formed with the second connection plate.

10. The battery assembly of claim 7, wherein
the plurality of cells are accommodated in the case such that a row of m cells and a row of m-1 cells are alternately arranged in a staggered manner, and
the first connection terminal and the second connection terminal are located at opposite ends of the row of m-1 cells.

11. The battery assembly of claim 7, wherein
the first connection terminal protrudes inwardly of the case, instead of protruding outwardly of the case,
the first connection terminal has a hollow cylindrical shape,
the second connection terminal has a hollow cylindrical shape, and
an internal diameter of the first connection terminal and the internal diameter of the second connection terminal are approximately the same.
